(19) United States
(12) Patent Application Publication
(10) Pub. No.: US 2002/0092475 A1
(43) Pub. Date: Jul. 18, 2002

(54) Handing bird feeder

(75) Inventors: William C. Paynton, Attleboro Falls, MA (US); Richard Paynton, Attleboro Falls, MA (US)

Correspondence Address: Barnes & Thornburg, Franklin Tower Bldg., Suite 500, 1401 Eye Street, N.W., Washington, DC, 20005, US

(73) Assignee: Improved Consumer Products, Inc.

(21) Appl. No.: 09/758,189

(22) Filed: Jan. 12, 2001

(51) Int. Cl. A01K 1/10; A01K 5/00; A01K 39/00

(52) U.S. Cl. 119/51.01

(57) ABSTRACT

A bird feeder having a hopper that has an open end and a closed end at opposing sides, and a scoop pivotally coupled near the open end so that the scoop is and selectively movable between a scooping position and a hanging position. In the scooping position, the scoop is lies generally parallel to the longitudinal axis of the bird feeder. In the hanging position, however, the scoop lies transverse to the longitudinal axis. In another embodiment, the bird feeder comprises a cage having a closed end and an open end at opposing sides, and a hopper the cage. Each of the cage and hopper have an open end facing a substantially single direction. A lid engages and covers the open end of the cage, and is selectively movable from a closed position covering the open end and an open position allowing the dispensation of bird seed into the hopper. Additionally, a hanger comprising a cord passes through apertures in the lid. The cord, lid and cage are configured so that weight of the bird feeder and its contents act to hold the lid on the cage when the bird feeder is hung.

### BACKGROUND AND SUMMARY OF THE INVENTION

The invention deals with bird feeders, and specifically a mesh-type hanging bird feeders.

Hanging bird feeders generally require one to deposit feed from above the feeder. Usually, a removable lid is placed over the feeder in order to provide some protection. Thus, in order to fill the feeder, the lids of these feeders must be removed and replaced. As birds access these feeders, the lids may become dislodged from the feeder, which not only exposes the feed to the elements, the dislodging of the lid may cause in spilling or loss of feed. Moreover, animals such as squirrels or raccoons may attempt to access the feed, and may damage the feeder. The current invention addresses each of these aspects.

One embodiment of the hanging bird feeder comprises a hopper having an open top end and a closed bottom end at opposing sides of a longitudinal axis. A scoop is pivotally coupled adjacent the open end and selectively movable between a scooping position and a hanging position. In the scooping position, the scoop is generally parallel to the longitudinal axis; in the hanging position, however, the scoop will lie transverse to the longitudinal axis.

In another embodiment, the hanging bird feeder is made up of a housing, which includes a hopper with an open top end and a closed bottom end at opposing ends of a longitudinal axis. A lid covers the open end of the hopper, and is selectively movable from a closed position (lid covering the hopper) and an open position (allowing one to deposit feed in the hopper). A cord passes through apertures in the lid to function as a hanger. The cord and lid are configured so that when the bird feeder is hung with the lid in the closed position, the lid is held onto the housing by force caused by weight of the bird feeder.

Other objects, advantages and novel features of the present invention will become apparent from the following detailed description of the invention when considered in conjunction with the accompanying drawings.

### BRIEF DESCRIPTION OF THE DRAWINGS

FIG. 1 is an exploded view of a first embodiment of the hanging bird feeder incorporating the principles of the present invention.

FIG. 2 shows the hanging bird feeder of FIG. 1, assembled and in a scooping position.

FIG. 3 shows the hanging bird feeder of FIG. 1, assembled and in a hanging position.

FIG. 4 is an underside view of the scoop of FIG. 1.

FIG. 5 is an exploded view of another embodiment of the hanging bird feeder.

FIG. 6 shows the hanging bird feeder of FIG. 5, assembled and shown in a hanging position.

FIG. 7 shows the hanging bird feeder of FIG. 5, shown in a filling position.

FIG. 8 is an exploded view of another embodiment of a hanging bird feeder in the filling position.

FIG. 9 shows the hanging bird feeder of FIG. 8, shown assembled and in a hanging position.

FIG. 10 is an exploded view of another embodiment of a hanging bird feeder according to the principles of the present invention.

FIG. 11 is a frontal view of the hanging bird feeder of FIG. 10, shown in the hanging position with lid in the closed position

FIG. 12 is a frontal view of the hanging bird feeder of FIG. 10, shown with lid in the removed position

FIG. 13 is another embodiment of the hanging bird feeder, shown with lid in the removed position.

FIG. 14 is another embodiment of the cage-type bird feeder, shown with lid in the closed position.

FIG. 15 is another embodiment of the cage-type bird feeder, shown with the lid in the closed position.

FIG. 16 shows a plan view of the lid.

### DETAILED DESCRIPTION OF THE PREFERRED EMODIMENT

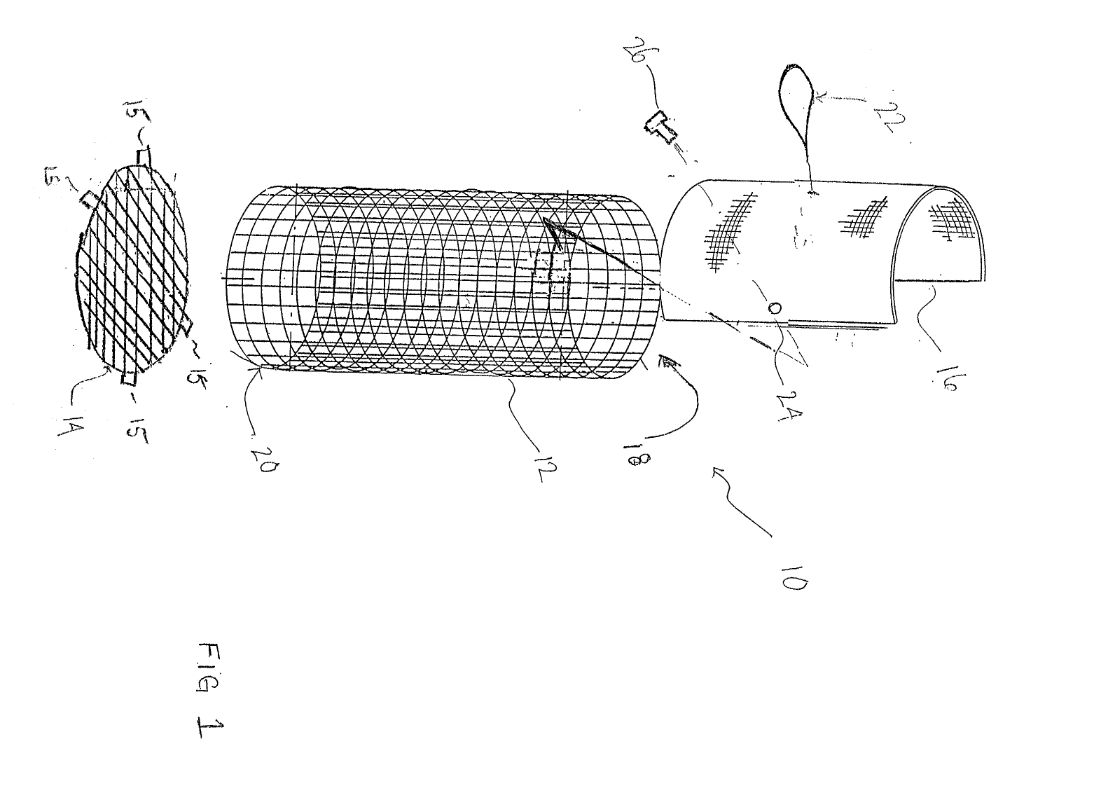

As shown in FIG. 1, the scoop-type bird feeder 10 comprises a hopper 12 having a top end 18 and a bottom end 20. A plate 14 is affixed adjacent the bottom end 20, and a scoop 16 is pivotally coupled adjacent the top end 18.

The plate 14 is shown as a mesh-type bottom. However, the bottom 14 may comprise a plate, with or without perforation. A mesh-type bottom allows moisture in the feed to drain.

The plate 14 may be secured near the bottom end 20 of the hopper 12 in a number of ways. For example, the hopper 12 may comprise a wire mesh that can be crimped around the plate 14. The plate 14 may have ears 15 formed to engage the hopper 12, and be crimped around openings in the wire mesh hopper 12 in order to form a sturdy, closed bottom end 20. The scoop 16 is coupled to the hooper 12 by a connector 26 which pass respectively through apertures 24 in the scoop 16. The connectors 26 pass through apertures 24 and engage openings in the hopper 12. Alternatively, the connector 26 may comprise a single bolt or rod passing through hopper 12 and apertures 24.

The feeder further comprises a hanger 22 connected to scoop 16. In the embodiment shown in FIGS. 1 through 3, the hanger 22 is a looped cord which engages scoop 16 by passing through an aperture 23. As shown in FIG. 4, once the loop passes through scoop 16, the hanger 22 is attached to a clip or catch 28, which prevents the hanger 22 from passing through the aperture 23. Of course, the hanger 22 need not be a looped cord, but may also comprise any other suitable hanging apparatus.

The catch 28 on the inner surface of scoop 16 will frictionally engage the outer surface of the hopper 12 when the scoop 16 is pivoted to the scoop position. The scoop 16 and the hopper 12 may be cooperatively formed so that the hopper 12 fits snugly into the scoop 16 in order to create additional frictional engagement when the scoop 16 is pivoted to the scoop position.

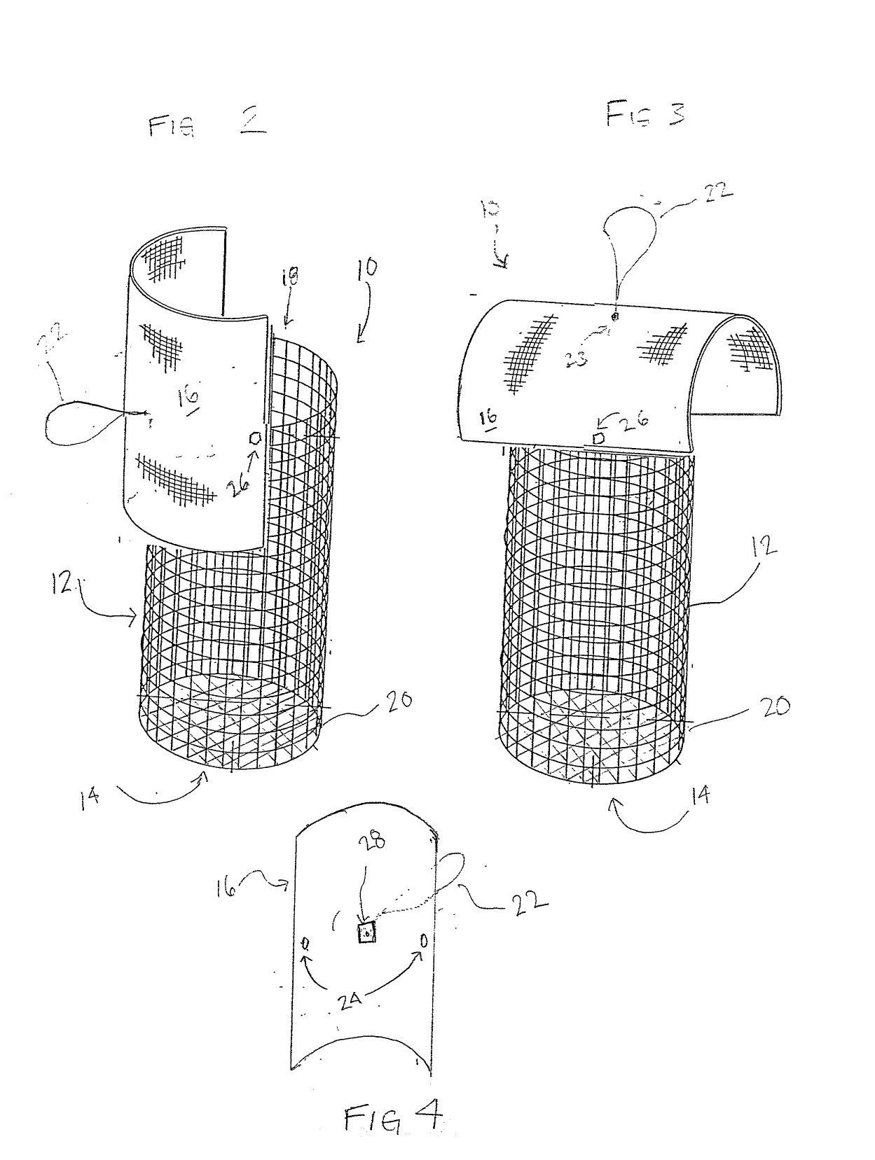

FIG. 2 shows the scoop-type bird feeder 10 in the scooping position. In this embodiment, the scoop 16 is rotated so that its longitudinal axis runs parallel to the longitudinal axis of the hopper 12. Preferably, the scoop 16 and hopper 12 are cooperatively configured such that, when the scoop is rotated to the scooping position, the scoop will substantially conform to the shape of the hopper. In order to increase the friction between the scoop 16 and the hopper 12 when the scoop is in the scooping position, the scoop 16 may have a slightly smaller, yet similar shape as the outer contour of the hopper 12 in order to create a tighter fit engagement of the hopper 12 in the scoop 16. Additionally, the catch 28 on the inner portion of the scoop 16 will engage a portion of the hopper 12 in order to frictionally retain the scoop 16 in the scooping position.

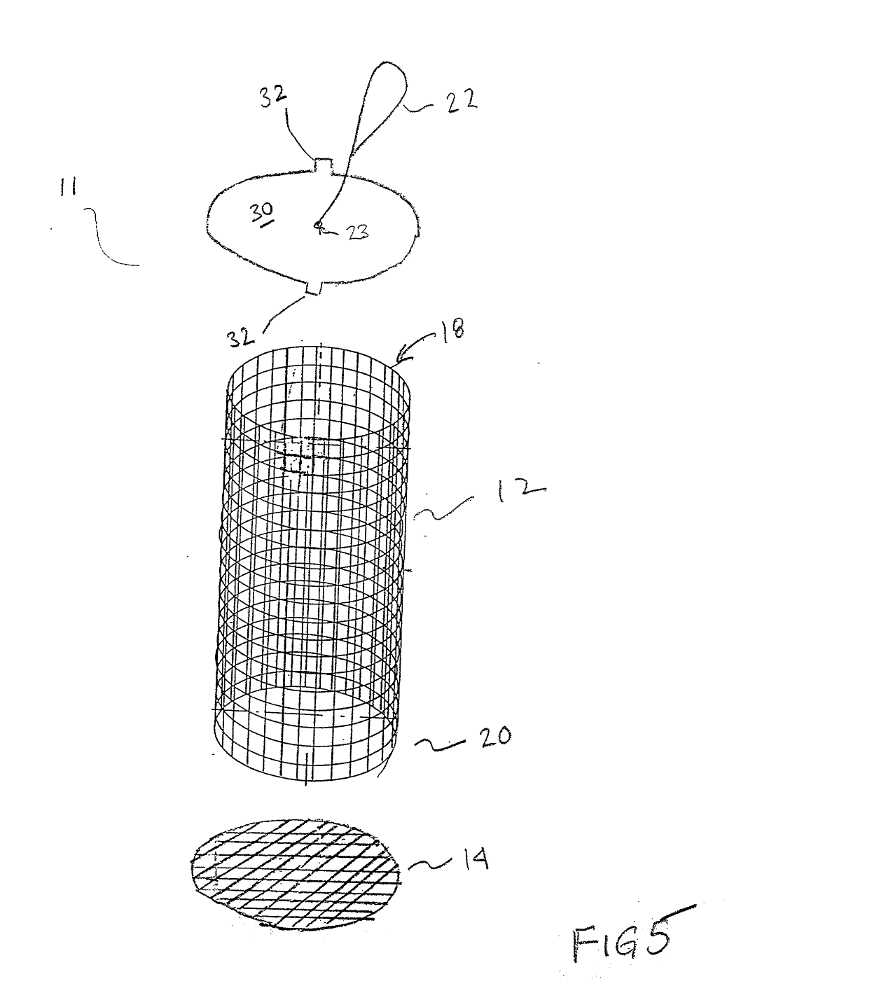

FIG. 3 shows the feeder 10 in the hanging position. When the scoop 16 is rotated to the hanging position, it may also function as a protective cover for the open end 18 of the hopper 12.

Although the hopper 12 and scoop 16 are shown to have generally circular or cylindrical shape, this shape is certainly not required. Indeed, rather than having a generally round bottom 14 the cross-sections may by polygonal. Additionally, even though the feeders are shown to have generally uniform and cylindrical cross-sections in FIGS. 1-3, the cross-section need not be uniform, but may take on numerous other designs as well.

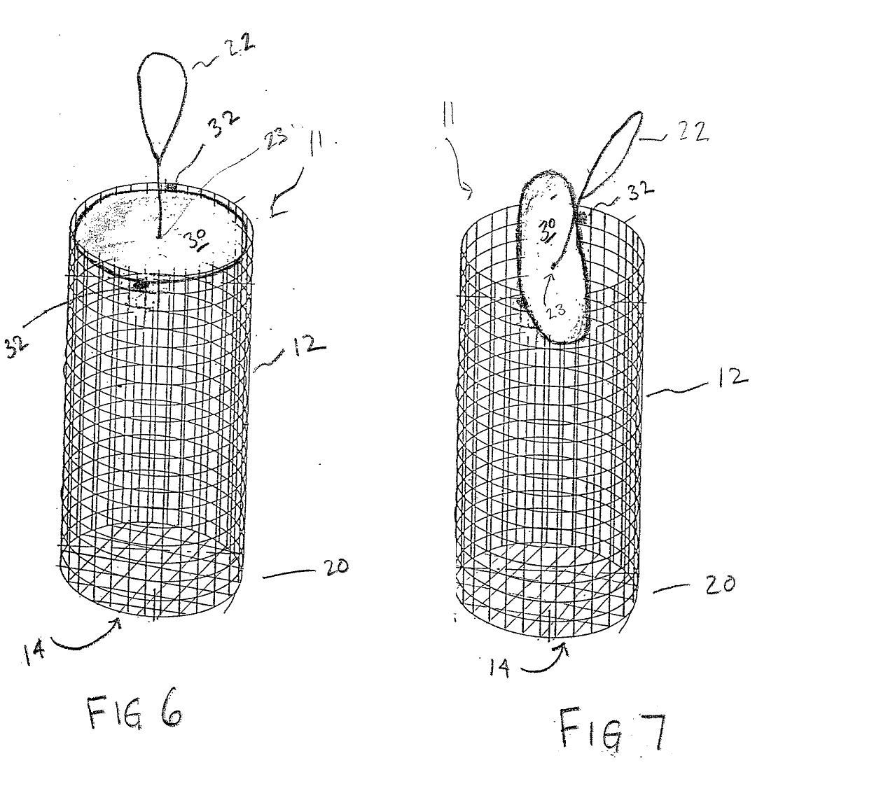

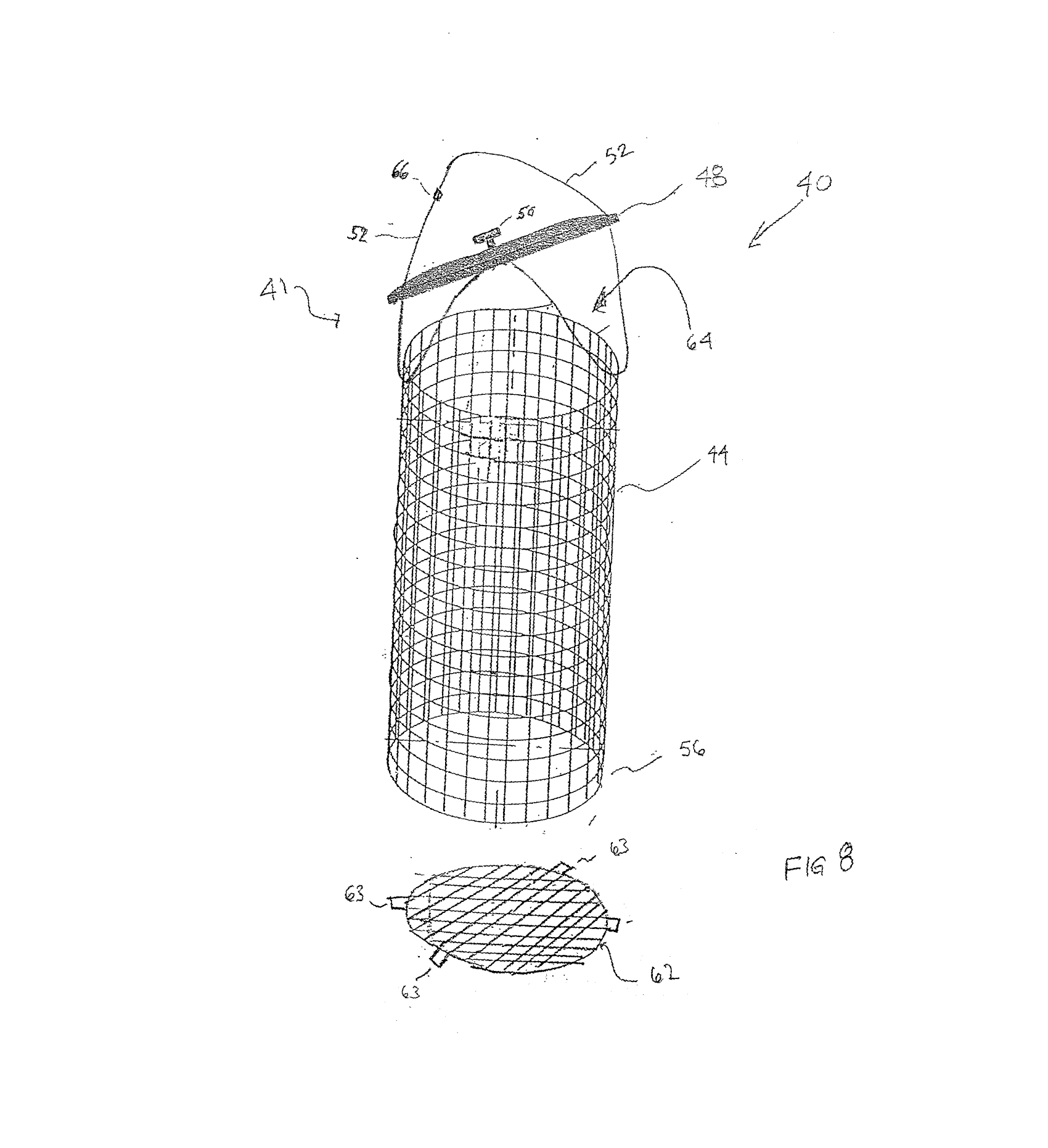

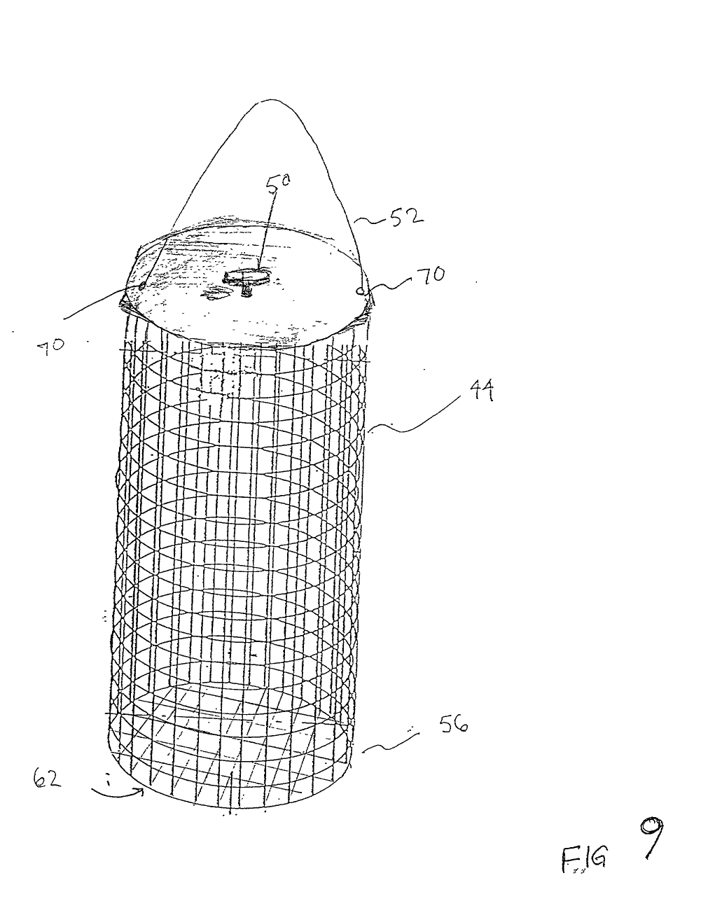

FIGS. 5-7 show an alternate embodiment of the hanging bird feeder 11. In this embodiment, the bird feeder 11 comprises a pivoting lid 30 with ears 32 which engage the hopper 12 and allow the lid 30 to be rotated from a hanging position, as shown in FIG. 6, to a loading position, as shown in FIG. 7. As with the bird feeder 10 shown in FIGS. 1-4, the alternate embodiment bird feeder 11 has a hanger 22 attached to the lid 30. As shown, the hanger 22 may comprise a looped cord that passes through an aperture 23 in the lid 30.

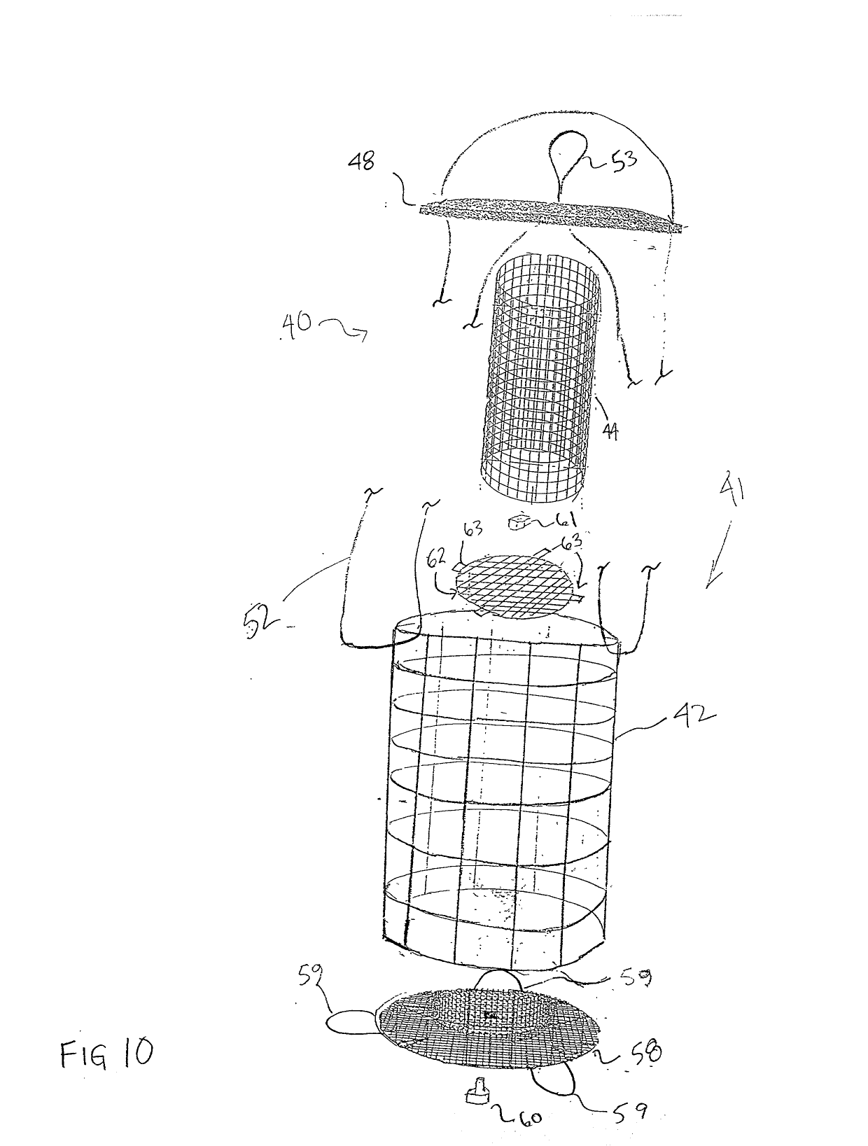

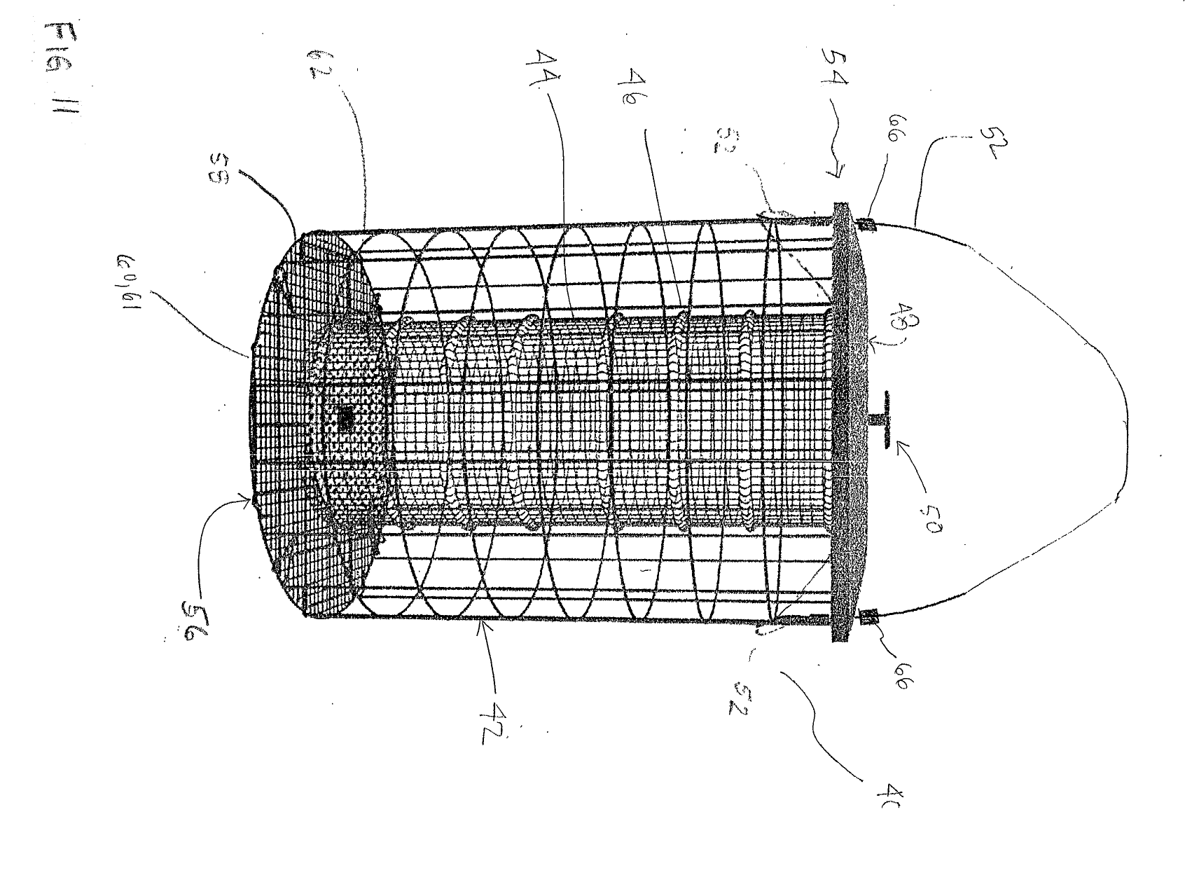

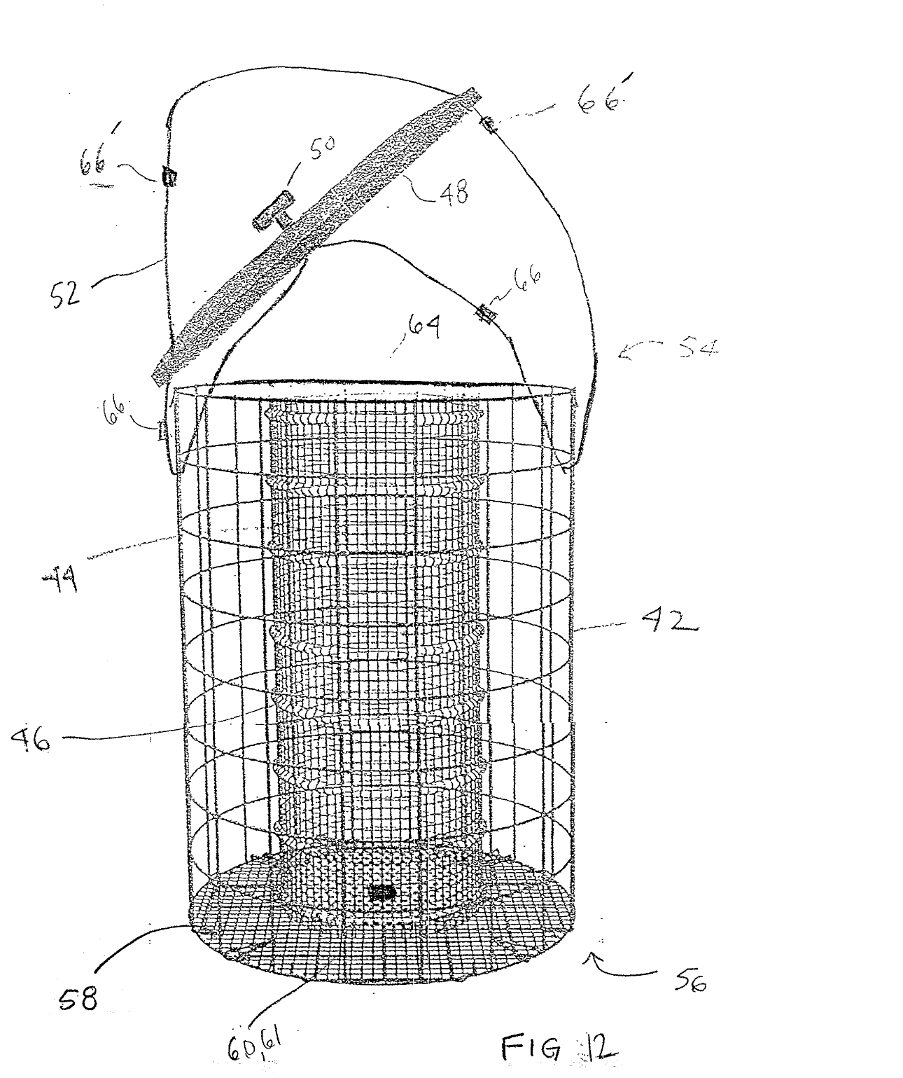

FIGS. 8 and 9 show another hanging feeder 40 according to the present invention. The feeder 40 comprises a housing 41 having a hopper 44. A lid 48 is formed to cover the housing 41. In this embodiment, the lid 48 is formed to engage the hopper 44 in the closed position. A cord 52 passes through holes 70 in the lid 48 (viewable in FIG. 16), and through openings in the hopper 44, and is fixed to the underside of the lid 48. Alternatively, the cord 52 may pass through a central hole 68 in the lid 48 and form a loop 53, as the cord 52 does in the embodiment shown FIGS. 10, 13 and 14. However, the embodiment shown in FIGS. 8, 9 and 11 show a handle 50 instead.

The hopper 44 will also comprise a bottom plate 62, which may be similar in character to the perforated plate 14 of the scoop-type hopper 10, as shown in FIGS. 1-3. The bottom 62 of the hopper 44 is affixed to the hopper adjacent the closed end by crimping the wire mesh of the hopper 44 around the plate 14. Additionally, the plate 14 may comprise ears 15 which can be crimped around the wire mesh of the hopper 44 in order to secure the plate. A fastener 60 passes through bottom 58 and plate 62 and mates with a nut 61 in order to secure the hopper 44 within the cage 42, and to hold the hopper 44 in a substantially concentric configuration within the cage 42.

FIGS. 8 and 9 also show a configuration of the cord 52. As shown, the cord 52 may be connected to an inner face of the lid 48 at a first end, then engage a first opening in the housing 41, then pass from the inner face of the lid 48 to an outer face of the lid 48 by passing through a hole (not shown in FIGS. 8 & 9, but viewable as 70, for example, in FIG. 16) positioned near a perimeter of the lid 48. The cord 52 then passes through a substantially oppositely-disposed hole (not shown in FIGS. 8 & 9, but viewable as 68, for example, in FIG. 16) on the lid 48 to engage a second opening in the housing 41, then connects to the inner face of the lid 48 at a second end of the cord 52, thereby forming a closed loop extending from the bird feeder 40.

In another configuration, the cord 52 forms a small loop 53 which passes through a centrally-located hole 68 in the lid 48 and extends from an outer surface of the lid 48. The cord 52 then extends to engage oppositely-disposed openings in the housing 41, and passes from the inner face of the lid 48 to the outer face of the lid 48 by passing through a hole 70 positioned near a perimeter of the lid 48. The cord 52 then extends to a substantially oppositely-disposed hole 70 on the lid 48 to engage an opening in the housing 41, thereby forming a large loop between the perimeter holes 70. In this configuration, the small loop may be selectively used as a handle, or to hang the bird feeder.

Each of the above configurations for the cord 52 may also work with not only the embodiments shown in FIGS. 8 and 9, but may also work well with the embodiments shown in FIGS. 10-15.

As shown in FIGS. 10-14, the housing 41 may comprise a hopper 44 and a cage 42. The hopper 44 is concentrically placed within a cage 42 formed of a sturdy mesh. The cage 44 has openings large enough to allow access to the hopper 44 by birds, yet prevent larger animals, such as squirrels or raccoons, accessing the hopper 44 and feed contained therein.

The hopper 44 may include a plurality of ribs 46 protruding outwardly from the hopper 44. The ribs 46 may be formed to provide a perch point for birds as they may land on the hopper 44 to feed. Preferably, the hopper 44 is formed of a mesh having opening large enough to allow a bird's beak to penetrate, yet retain bird feed within the hopper 44.

A bottom 58 is coupled to the cage 42 adjacent the bottom end 56 of the bird feeder 40. The coupling may be achieved by outward-facing, pliable retainers 59 on the bottom 58 which may be crimped onto cage 42 in order to retain the bottom 58 to the bottom end 56 of the cage 42. The bottom 58 is shown to be a mesh, which allows for aeration of the feed; however, the bottom 58 may comprise a plate, with or without perforation.

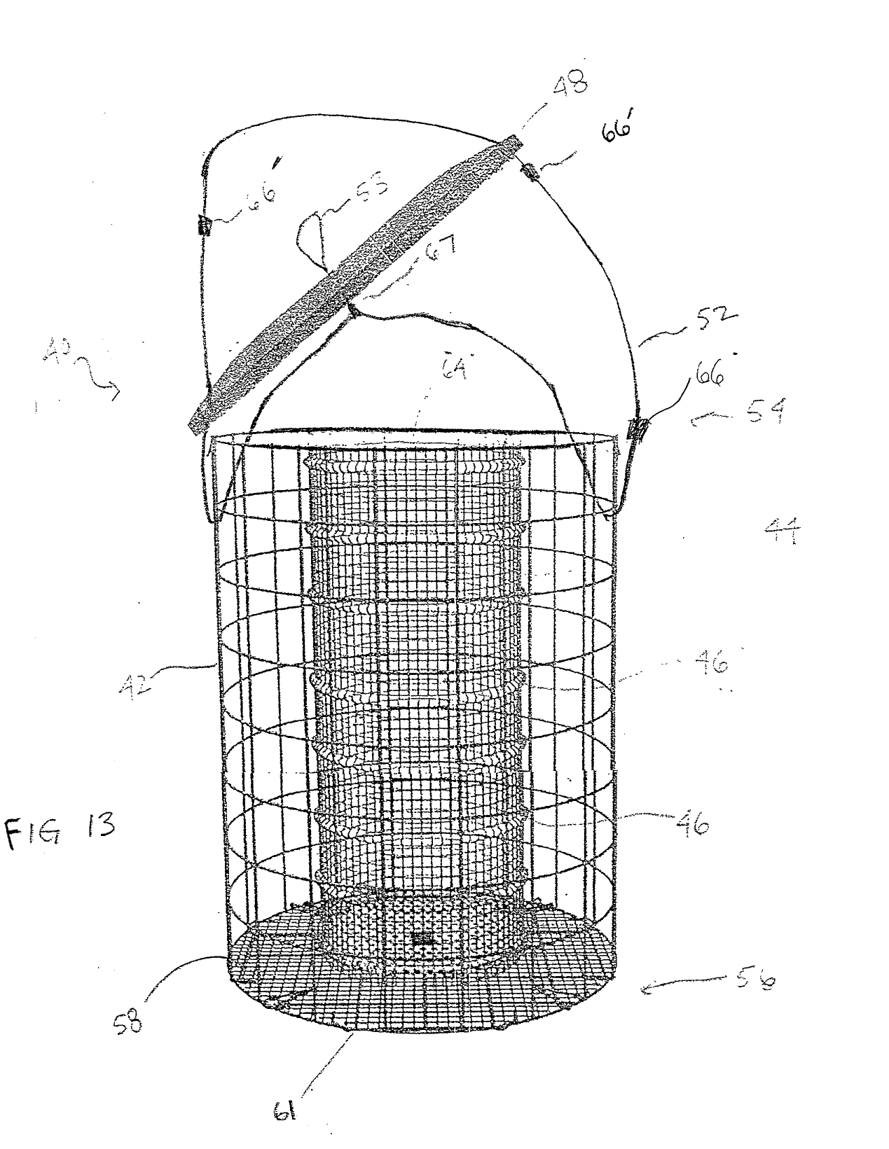

A lid 48 is secured to the top end 54 of the bird feeder 40 by means of a cord 52 which passes through the lid 48, and engages the cage 42. The lid 48 may also comprise a handle 50 as shown in FIGS. 11 and 12.

As shown in FIGS. 11 and 12, for example, the cord 52 may comprise a single loop which passes through the lid 48, engages the cage 42 near the top end 54, and is fixed to the underside of the lid 48. In this configuration, as shown in FIG. 12, the weight of the bird feeder and its contents keeps the lid 48 secured to the open end 54 of the bird feeder 40.

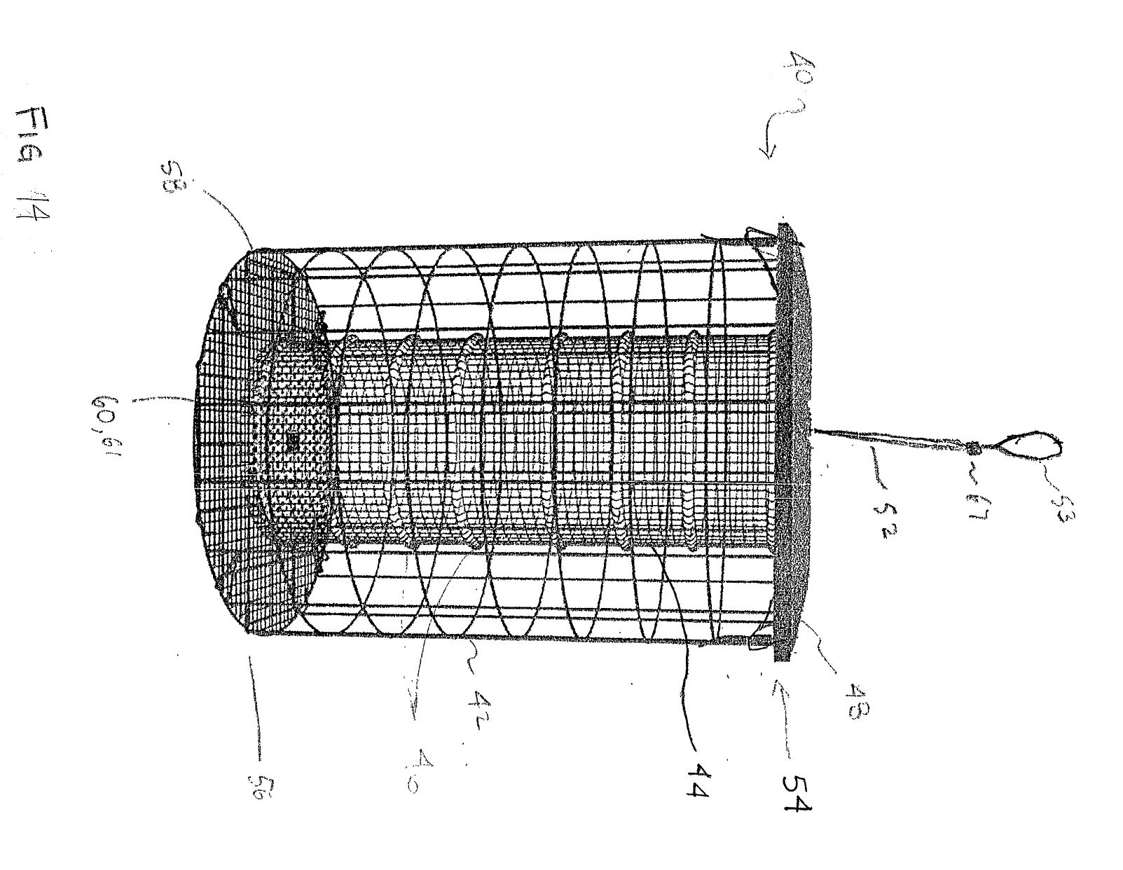

As shown in FIG. 13, the handle 53 may comprise an inner looped cord. The inner looped cord 53 is a loop formed from the continuous loop 52. A catch 67 may be configured near the lower end of the inner loop 53 in order to prevent it from passing through an aperture 68 (viewable in FIG. 16) located in the lid 48.

Additional catches 66′ may be selectively placed along the cord 52 in order to engage lid 48 and hold lid in selected positions. As shown in FIGS. 12 and 13, additional catches 66′ may be placed on the cord 52 in order to engage underside of the lid 48 to hold it in an open position. As shown in FIG. 11, additional catches 66′ may be selectively placed on the cord 52 in order to engage the outer surface of the lid 48 in order to assist in holding the lid 48 in the closed position.

Referring to FIG. 16, the lid 48 is configured with opposed perimeter holes 70. The perimeter holes 70 are pear-shaped; this shape allows the catch 66 to pass through a larger portion 71 of the hole 70, yet engage a narrower portion 73 of the hole 70. In this way, the catch 66 positioned underneath the lid 48 may maintain the lid in the open position, and a catch 66 positioned above the lid 48 may keep the lid in a closed position.

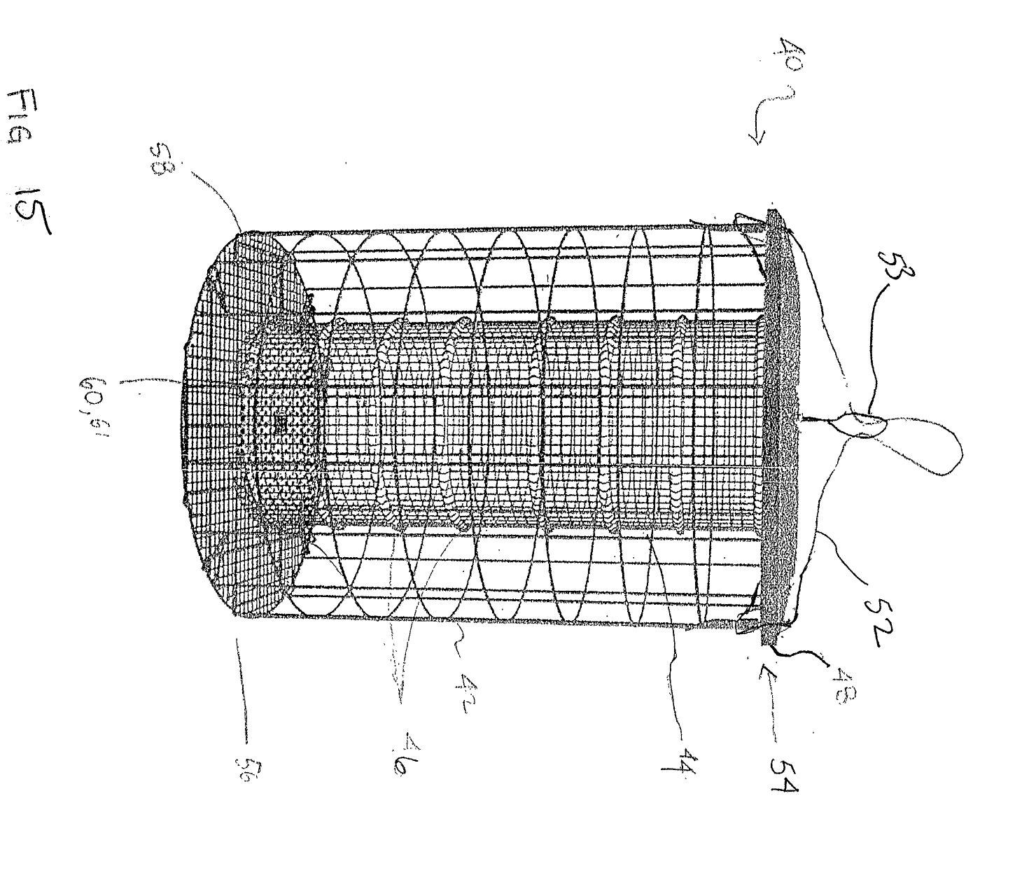

FIG. 14 shows an alternate embodiment, and an alternative configuration for the cord 52. In contrast with the embodiment shown in FIG. 13, a catch 67 is configured on the outer side of lid 48, but no catch is positioned on the cord 52 inside the central hole 68. Therefore, the loop 53 may be used as a hanging loop, rather than a handle-type loop, and may be pulled taut so that cord 52 holds lid 48 snugly against the upper portion 54 of cage 42.

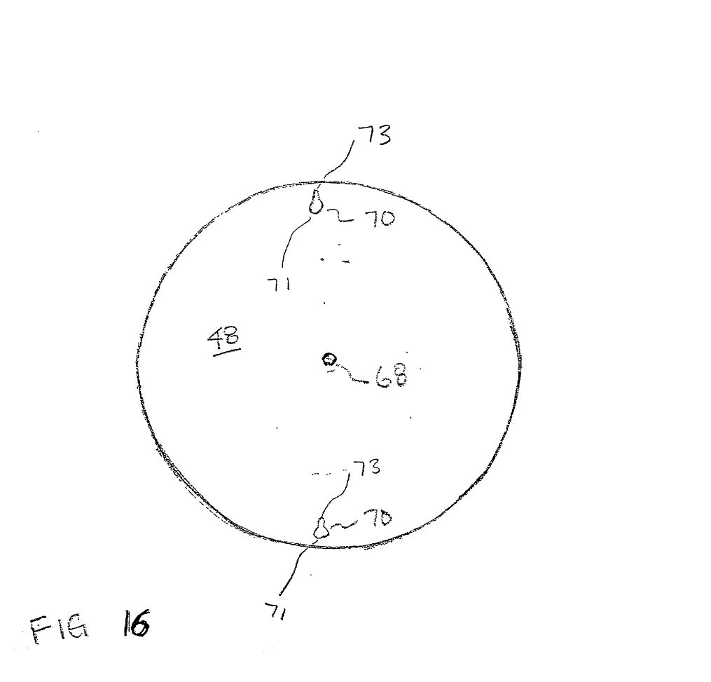

Referring to FIG. 15, the cord 52 may be configured in yet another way. In this configuration, the cord 52 forms a small loop 53 which passes through a centrally-located hole 68 in the lid 48 and extends from an outer surface of the lid 48. The cord 52 then extends to engage oppositely-disposed openings in the housing 41, and passes from the inner face of the lid 48 to the outer face of the lid 48 by passing through a hole 70 positioned near a perimeter of the lid 48. The cord 52 then extends to a substantially oppositely-disposed hole 70 on the lid 48 to engage an opening in the housing 41, thereby forming a large loop between the perimeter holes 70. The larger loop of cord 52 is then passed through the smaller loop 53, then the larger loop of cord 52 is pulled taught and used to hang the bird feeder.

FIGS. 8 and 9 also show a configuration of the cord 52. As shown, the cord 52 may be connected to an inner face of the lid 48 at a first end, then engage a first opening in the housing 41, then pass from the inner face of the lid 48 to an outer face of the lid 48 by passing through a hole (not shown in FIGS. 8 & 9, but viewable as 70, for example, in FIG. 16) positioned near a perimeter of the lid 48. The cord 52 then passes through a substantially oppositely-disposed hole (not shown in FIGS. 8 & 9, but viewable as 68, for example, in FIG. 16) on the lid 48 to engage a second opening in the housing 41, then connects to the inner face of the lid 48 at a second end of the cord 52, thereby forming a closed loop extending from the bird feeder 40.

In any of these cord-configurations, the catch 67 should be configured such that it will not pass through central hole 68 in the lid 48. In yet another alternate embodiment (not shown) a catch 67 may be placed both on the inside and outside of the lid 48 on either side of the hole 68, thereby making a substantially stationary loop 53.

Although the present invention has been described and illustrated in detail, it is to be clearly understood that the same is by way of illustration and example only, and is not to be taken by way of limitation. The spirit and scope of the present invention are to be limited only by the terms of the appended claims.

We claim:

1. A bird feeder comprising:
a hopper having a top end and a bottom end at opposing sides of a longitudinal axis;
a scoop pivotally coupled adjacent the open end and selectively movable between a scooping position and a hanging position; and,
the scoop in the scooping position lies generally parallel to the longitudinal axis, and the scoop in the hanging position lies transverse to the longitudinal axis.

2. The bird feeder of claim 1, wherein the hopper comprises a mesh formed to retain seeds within the hopper but allow a bird's beak to enter the hopper.

3. The bird feeder as in claim 2, further comprising at least one rib protruding radially outward from an outer surface of the hopper.

4. The bird feeder as in claim 1, further comprising a perforated plate adjacent the closed end.

5. The bird feeder as in claim 4, wherein the plate is coupled to the hopper by crimping the wire mesh to engage the plate and form a sturdy bottom end.

6. The bird feeder as in claim 4, wherein the plate includes at least two ears formed to engage the wire mesh and be crimped around the wire mesh to form a sturdy bottom end.

7. The bird feeder as in claim 1, wherein the scoop being pivotally connected to the hopper by at least one bolt extending through the scoop and into the hopper, thereby defining an axis of rotation for the scoop.

8. The bird feeder as in claim 1, further comprising a hanger attached to the scoop.

9. The bird feeder as in claim 8, wherein the hanger comprises a cord passing through at least one aperture and forms a loop extending from the bird feeder.

10. The bird feeder as in claim 1, wherein the scoop and hopper are cooperatively formed so that the scoop snugly and frictionally engages the hopper when the scoop is in the scooping position, and the scoop lies above the open end when in the hanging position.

11. A bird feeder, comprising:
a housing including a hopper with an open top end and a bottom end at opposing ends of a longitudinal axis;
a lid covering the open end of the hopper, and selectively movable from a closed position covering the open top end and an open position allowing the dispensation of bird seed into the hopper; and,
a hanger comprising a cord which passes through apertures in the lid and the housing so that when the bird feeder is hung with the lid in the closed position, the lid is held onto the housing by force caused by weight of the bird feeder.

12. The bird feeder as in claim 11, wherein the housing further includes a cage having a top end and a bottom end at opposing sides of the longitudinal axis, and positioned concentrically around the hopper.

13. The bird feeder as in claim 12, further including a bottom secured adjacent the bottom end of the cage, and a connector securing the bottom to the bottom end of the hopper.

14. The bird feeder as in claim 13, wherein the bottom is a mesh.

15. The bird feeder as in claim 12, wherein the cage is formed with openings large enough to allow selected birds to pass therethrough, yet prevent larger animals from accessing the hopper; and
the hopper is formed to retain bird food, and comprises a mesh with openings large enough to allow a bird's beak to pass therethrough.

16. The bird feeder as in claim 11, further comprising a plate secured adjacent the bottom end of the hopper.

17. The bird feeder as in claim 16, wherein the plate is perforated to allow aeration of bird food held in the hopper.

18. The bird feeder as in claim 11, further comprising a handle on the lid.

19. The bird feeder as in claim 11, wherein a first end of cord is joined to the second end of the cord, thereby forming a continuous looped cord.

20. The bird feeder as in claim 11, wherein the cord forms a small loop which passes through at least one centrally-located hole formed on the lid, the small loop extending from an outer surface of the lid, the cord then extending to engage oppositely-disposed openings in the cage, and passing from the inner face of the lid to the outer face of the lid by passing through a hole positioned near a perimeter of the lid, then extends to a substantially oppositely-disposed hole on the lid to engage an opening in the cage, thereby forming a large loop between the perimeter holes; whereby, the small loop may be selectively used as a handle, or to hang the bird feeder.

21. The bird feeder as in claim 11, wherein the cord is connected to an inner face of the lid at a first end, then engages a first opening in the housing, then passes from the inner face of the lid to an outer face of the lid by passing through a hole positioned near a perimeter of the lid, then extends to pass through a substantially oppositely-disposed hole on the lid to engage a second opening in the housing, then connects to the inner face of the lid at a second end of the cord, thereby forming a closed loop extending from the bird feeder.

22. The bird feeder as in claim 21, wherein the first and second openings are formed on a cage positioned around and substantially concentric with the hopper.

23. The bird feeder as in claim 21, further comprising at least one catch positioned on the closed loop, the at least one catch configured to engage the lid adjacent the at least one hole in order to retain the lid in a selected position.

24. The bird feeder as in claim 23, wherein the at least one catch is configured to retain the lid in the closed position.

25. The bird feeder as in claim 23, wherein the at least one catch is configured to retain the lid in an open position.

26. The bird feeder as in claim 21, wherein at least one of the holes has wide portion which freely allows the catch to pass through, and a narrow portion configured to engage the catch.

27. The bird feeder as in claim 26, further comprising a catch closing the small loop, thereby preventing the small loop from passing through the at least one centrally-located hole in the lid.
